(19) United States
(12) Patent Application Publication
(10) Pub. No.: US 2024/0409708 A1
(43) Pub. Date: Dec. 12, 2024

(54) 3D Printable Carbonated Polymer

(71) Applicant: Fareed Dawan

(72) Inventor: Fareed Dawan

(21) Appl. No.: 18/208,825

(22) Filed: Jun. 12, 2023

(51) Int. Cl. C08K 3/20; B33Y 70/00

(52) U.S. Cl. CPC C08K 3/20; B33Y 70/00

(57) ABSTRACT

The invention uses gas molecules as fillers in a polymer matrix to create a carbonated polymer with improved thermal and mechanical properties. These carbonated polymers can be 3D printed into various shapes using DLP technology.

### FIELD OF INVENTION

The present invention generally relates to a 3D printable polymeric material. More particularly, the invention relates to a 3D printable polymeric material carbonated with gas.

### BACKGROUND OF THE INVENTION

As engineering requirements for materials become stricter, engineers need a greater selection of materials from which to choose. Composites serve as an effective approach to this demand since they are tailorable to a myriad of applications. Furthermore, the option of creating complex shapes from the composite provides an additional expansion of its use.

Engineers have increasingly turned to polymer composites to fill their material needs. Polymer composites are comprised of two parts: the light-weight polymer matrix, which constitutes the bulk of the material and functions as the major load bearer, and the filler which functions as an enhancement to the polymer matrix. The effective composition of these polymer composites provides solutions to problems where ordinary polymers and metals fail. For example, the composition of the polymers and filler exhibit useful properties including increased surface area, conductivity, and high strength. When fillers, such as, metal or nonmetal micro or nano-particulates are included in the polymer matrix a multifunctional polymer composite material is created that is versatile, light-weight, and easily formable.

Polymer composites which incorporate solid particulates or fibers within a polymeric matrix have been instrumental in structural and functional applications in a myriad of fields, including medical, aerospace, vehicular and the electronic industry. Voids or gas bubbles are inherently introduced into the composite during the manufacturing process which adversely affects the properties of the material. What is needed is a way for gas bubbles to enhance functionality of the polymer material just as solid particulates do within a composite, thereby expanding the definition of polymer composite materials to include gas bubbles as matrix fillers. If such a polymer could be 3D printed, the polymer would further enhance the functionality and applicability of the material.

### BRIEF DESCRIPTION OF FIGURES

The present invention may be understood with reference to the following drawing figures in which like elements and numerals denote like elements, and in which:

FIG. 1 depicts an exemplary thermal stability graph of a gas molecule filler at 1 atm useful with various exemplary embodiments of the present invention;

FIG. 2 depict a carbonation system that may be used in accordance with various embodiments of the present invention;

FIG. 3 depicts a carbonated polymer resin according to various embodiments of the present invention;

FIG. 4 is an image of a 3D printed carbonated polymer coupon printed according to the present invention;

FIG. 5 is an image of 3D printed carbonated polymer coupons according to the present invention;

FIG. 6 shows the effect of carbonation and post-UV exposure time on polymer weight;

FIG. 7 is an exemplary illustration of a 3D printing process for 3D printing carbonated photosensitive resin to form carbonated polymer coupon in accordance with exemplary embodiments of the present invention; and

FIG. 8 is an exemplary illustration of a 3D printing process for 3D printing carbonated photosensitive resin to form carbonated polymer coupon in accordance with exemplary embodiments of the present invention.

### BRIEF SUMMARY OF THE INVENTION

The present invention teaches using gas molecules as a filler within a polymer matrix. This suggestion is largely counter-intuitive, since generally, pockets of air (gas) or voids in composites and in materials are categorized as defects and cause adverse effects to the overall material property and performance. Indeed, extensive work has been done to find ways to detect voids (gas bubbles) and their formation to identify structural weaknesses in the polymeric composite. Even more research has been directed to avoiding and removing gas bubbles from resin during manufacturing.

Contrarily, instead of removing the gas, the present invention teaches intentionally introducing gas microbubbles in a polymer matrix to create a carbonated polymeric material (“carbonated polymer”) that exhibits a wider thermal range and more suitable mechanical properties for engineering design than conventional composite or materials. The invention further teaches that the carbonated polymers may be 3D printed into any 3D printable shape using Digital Light Projection (DLP).

### DETAILED DESCRIPTION OF THE INVENTION

The present invention teaches including gas microbubbles in a composite polymer as a filler. It is well known that the term “gas” refers to a state of matter in which substances are in a gaseous form, characterized by having no definite shape or volume. Gases are composed of gas molecules as their basic unit. The behavior and properties of gases, such as their expansion, compression, diffusion, and the relationship between pressure, volume, and temperature, are all understood through the study of gas molecules and their interactions.

A suitable gas useful with this invention has a gas molecule with molecular weight of 30 amu or greater and a density greater than 1.204 kg/m\hat{ }3. The present invention is described using carbon dioxide as a filler only by way of example. The invention contemplates using other gases in the carbonated polymer design, where such gas meets the molecular requirements described above.

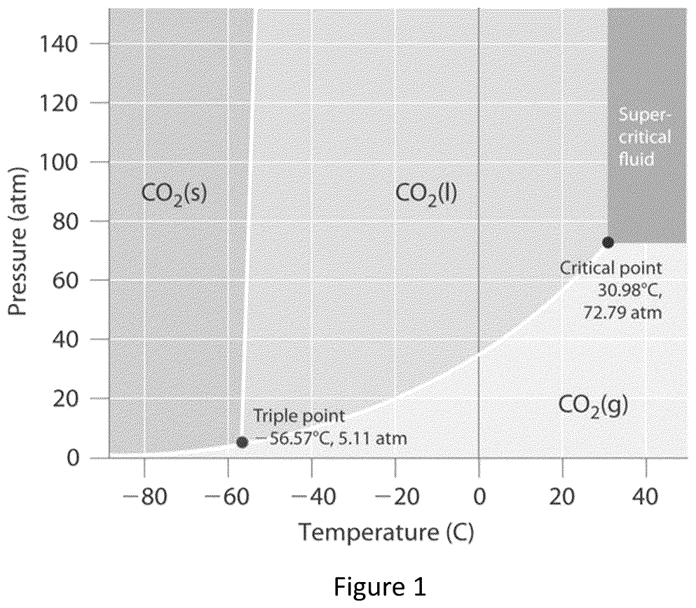

The exemplary embodiment of the invention described herein use carbon dioxide (CO₂) as the filler constituent of a polymeric composite created according to the present invention. FIG. 1 is the phase diagram of CO₂ illustrating the phase state and transformations of the molecule due to changes in pressure and temperature. In terms of material selection, the purpose of FIG. 1 is to provide some information pertaining to the properties of the molecule we intend on using as the filler or enhancement to the neat thermoset polymer. FIG. 1 shows 1) the thermal stability of the gas molecule filler at 1 atm (for manufacturing, material utility, and operational purposes) and 2) the conditions necessary to transform the phase of the CO₂ filler, for material application purposes.

In one exemplary embodiment of the invention, the printed polymeric composite including the CO₂ filler may be used to store CO₂ for later use. For example, the present invention teaches a system and storage medium that may be used to store a personal, portable, and on-demand CO₂ phase transformation. FIG. 1 shows the usefulness of CO₂ in storage mediums as described herein. The phase diagram indicates that the critical point to transform the CO₂ gas into a supercritical fluid occurs at a minimum temperature and pressure of 30.98° C. and 72.79 atm (7.38 MPa), respectively. Release or storage of supercritical fluids within porous materials have proved useful in solvent extraction, porous polymer synthesis, lithography, and food processing applications.

Recently, in his work titled “Syntheses, properties, and applications of CO₂-based functional polymers,” Tang et al reviewed CO₂-based functional polymers in which CO₂ was used to create enhanced polymers. Tang et al reported that by using CO₂ as a precursor, advanced polymers could be formed. For example, CO₂-based polycarbonates showed superior thermal properties over typical PPCs. Tang, et al. also reviewed CO₂-derived polyhydroxyurethanes (PHUs) which were found to be 3D printable by extrusion-based fused deposition modeling.

In contrast to Tang et al, the present invention doesn't use CO₂ as a precursor. The present invention teaches 1) infusing CO₂ in its gas state (microbubbles) into a photosensitive thermoset polymer to create a carbonated polymer composite, and 2) 3D print the now carbonated polymer composite. Contrary to Tang, et al, which uses extrusion-based deposition, the present invention uses Digital Light Projection (DLP).

In accordance with various embodiments of the invention a photosensitive resin is carbonated. A gas is forced into the photosensitive resin at room temperature and pressure using forced carbonation in similar manner as is done with carbonating liquids and recently, cement. By “carbonate” what is meant is high pressure carbon-dioxide gas is passed through the photosensitive resin, wherein a portion of the carbon dioxide dissolves and remains in the photosensitive resin. A suitable photosensitive resin for use with the present invention may be any composition of a water-soluble polymer such as isomalt or a non-water-soluble polymer such as acrylate with a UV photoinitiator such as a norrish type II free-radical generator.

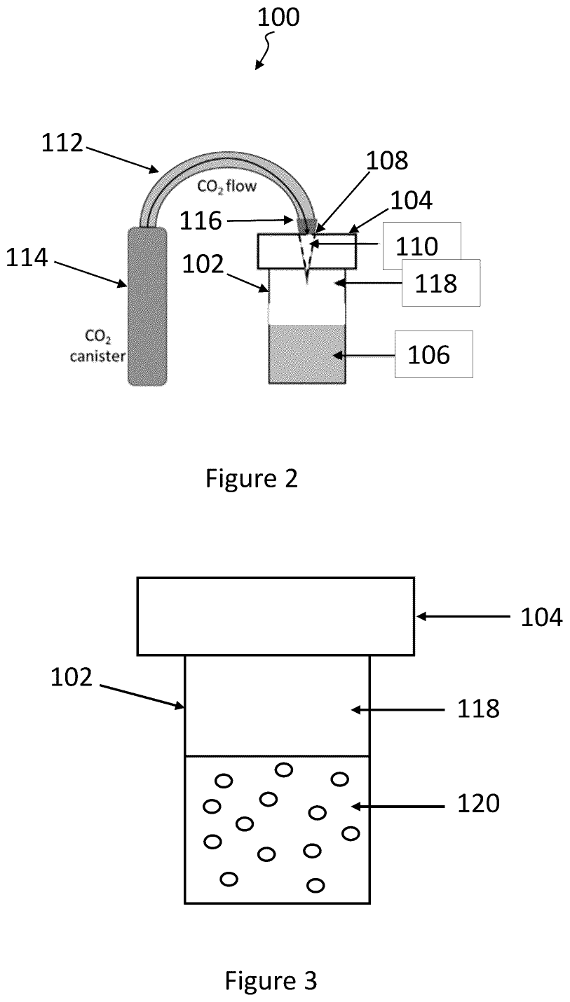

FIG. 2 depicts an exemplary carbonation system 100 for infusing a photosensitive resin with CO₂ according to various embodiments of the present invention. As shown, carbonation system 100 includes a vial 102 including a cap 104 for sealing via 102 against ambient air. Vial 102 may include a photosensitive resin 106 contained therein. In one particular embodiment, the photosensitive resin 106 may not completely fil the canister 102. For example, vial 106 may include atmospheric air 118 including CO₂.

Cap 104 may include an aperture 108 to accommodate a pipette tip 110. Pipette tip 110 may be further connected a tube assembly 112 for the flow of CO₂. Tube assembly 112 may further include a valve 116 for regulating the flow of the CO₂. Tube assembly 112 may be further connected to a CO₂ canister 114 for providing CO₂. The present invention uses a 16-gram canister of CO₂ as the source of the CO₂ for carbonating photosensitive resin 106. In one particular embodiment, canister 114 may include CO₂ gas under pressure.

Vial 102 may be a dark container and have an inner lining which will not chemically react with the resin or gas being used. In one particular embodiment, a dark brown glass vial may be used. This is required since the resin is sensitive to light, Further, the dark vial minimizes or eliminates the exposure to ambient light during the carbonation process. Tube assembly 112 may be any tube assembly capable of transporting CO₂ from a canister. A suitable canister 114 for use with this invention may be any canister capable of storing CO₂ gas and providing CO₂ gas for use in a carbonation process. An exemplary canister 114 may be, for example, a 16-gram canister of CO₂ sold by Leland Gas Technologies. Valve system 116 may be any suitable valve for regulating the flow of gas in a tube, such as for example a Presta™ Valve Stem.

During operation, CO₂ canister 114 is connected to tube assembly 112, such that canister 114 provides CO₂ gas to tube assembly 112. Tube assembly 112 transports the CO₂ gas to valve 116. Valve 117 may be in communication with pipette tip 110. Pipette tip 110 may be placed into aperture 108 for providing CO₂ gas into atmospheric air 118 under pressure. Pipette tip 110 may be placed in cap 104 such that the CO₂ does escape from and remains in vial 102. Pipette tip 110 may be sealed to aperture 108 using, for example, a conventional O-ring or other suitable rubber seal. In another suitable sealing arrangement, aperture 108 may be itself sealed with a puncturable film, such as silicon. In which case, pipette tip 110 may pierce the silicon film to provide the CO₂ to vial 117.

Valve 116 may regulate the gas flow flowing from the tubing assembly 112 into vial 102 of resin. As previously noted, the CO₂ gas contained in canister 102 is under pressure. As such, the vial cap aperture 108 may be sealed around pipette tip 110, such that any CO₂ included in vial 102 does not leave. In one exemplary embodiment, aperture 108 may be sealed. The sealed vial 102 may be placed into a mixer for mixing (not shown) the constituents included in shaker mill, or laboratory grinder used to grind, pulverize, or mix samples to analytical fine matter. The sealed vial 102 may then be shaken for intervals of 5, 10, 15, 20, 25, 35, and 45 seconds to generate carbonated photosensitive resin 120, shown in FIG. 3.

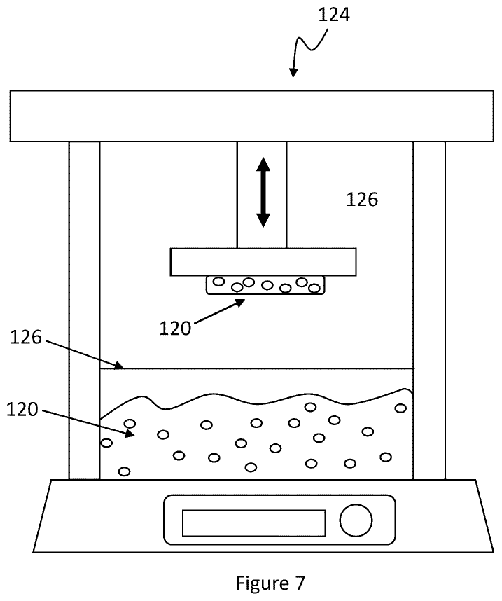

With brief reference to FIG. 7, carbonated photosensitive resin 120 may be 3D printed using, for example, a Digital Light Projection 3D printer 124. For example, carbonated photosensitive resin 120 may be poured into 3D printer vat 126. 3D printer build plate 128 may move vertically such that build plate 128 in submerged in the carbonated photosensitive resin 120. As described more fully below, each layer of the printed carbonated photosensitive resin is subjected to UV wavelength. 3D printer 124 may be operated on carbonated photosensitive resin 120 to 3D print carbonated polymer coupon 122.

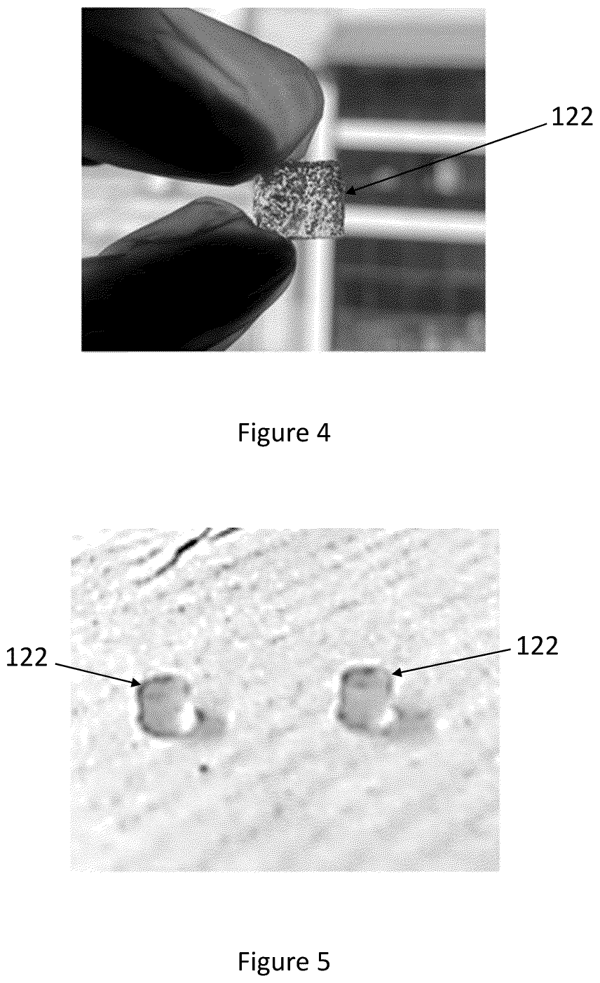

FIG. 4 is an image of a 3D printed carbonated polymer coupon 120 printed according to the present invention. FIG. 5 is an image of 3D printed carbonated polymer coupons 120 according to the present invention. In this example, the final dimensions for the cylindrical carbonated polymer coupons 120, shown in FIG. 4 and FIG. 5, is 4 mm in diameter with 1.7 mm in height for porosity and thermal testing, and 4 mm in height for mechanical testing.

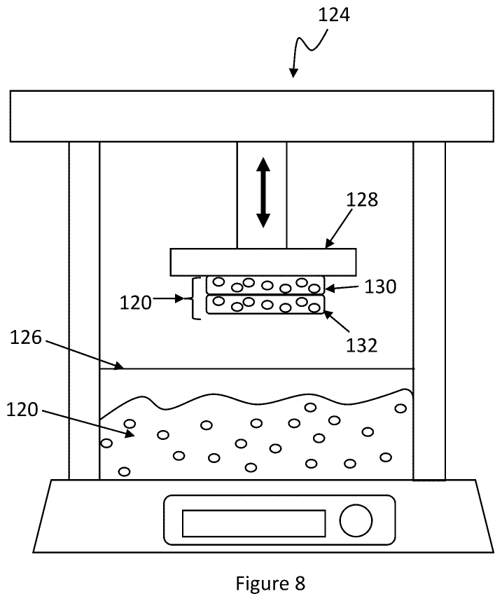

In one embodiment, referring now to FIG. 8, an exemplary 3D printing of the carbonated polymer coupons 120 is depicted. As shown in FIG. 8, carbonated polymer coupons 120 is composed of a 200-μm thick base layer of carbonated polymer (“base layer 130”) composed of four 50-μm layers of carbonated polymer resin, which is first printed. Each of the 50-μm layers of carbonated polymer resin of base layer 130 is exposed at a dose of 87 mJcm⁻² to ensure that the base layer 130 adheres to the surface of the build plate 128 to aid in print completion. The base layer 130 may be exposed to a UV peak wavelength of 405 nm. The subsequent 50-μm thick layers (“subsequent layers 132”) were each exposed at a dose of 3.8 mJcm⁻², resulting in an approximate total UV exposure dosage of approximately 1-2 Jcm⁻² for each completed 3D printed carbonated polymer coupons 120. The completed 3D printed carbonated polymer coupons 120 may then be soaked and rinsed with isopropanol alcohol IPA for 2 min and allowed to air dry for 5 min. Once dried, the completed 3D printed carbonated polymer coupons 120 may be placed in storage environment, wherein the storage area is dark and moisture free.

It is important to note that the parameters for 3D printing discussed herein may differ depending on the gas used, resin formulation used, and the desired 3D print as determined by the 3D printer used.

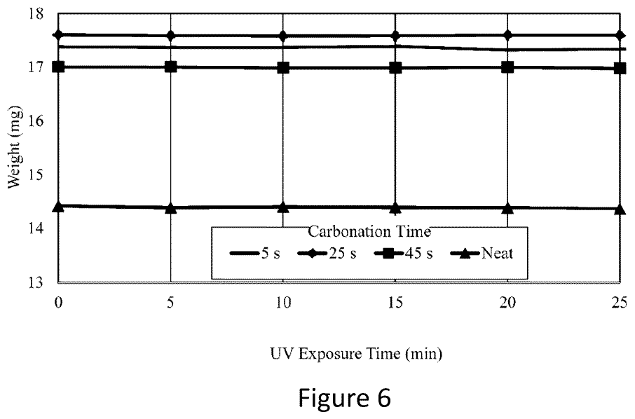

FIG. 6 shows the effect of carbonation and post-UV exposure time on polymer weight. The weight of the neat polymer is 14.5 mg, whereas the weight of the carbonated samples is about 21% higher. This indicates that carbonation results in an increase in mass, reinforcing the idea that the CO₂ microbubbles are not behaving as true voids but instead as matrix fillers.

It is important to note that the microbubbles CO₂ gas behaves as a solid filler component in a composite material. Therefore, the microbubbles CO₂ gas may not be interpreted as pores or voids and do not directly factor into the change in the porosity. Instead, the change is due to surface interfacial voids that are formed between the microbubbles and the polymer matrix.

Additive manufacturing of the carbonated polymer composite proved possible using the digital light projection (DLP) 3D printing technique. Characterization revealed that the CO₂ gas molecule physically behaves as a solid particulate filler. This observation gives rise to the consideration of utilizing an assortment of other gas molecules and mixtures with unique properties as polymer enhancement fillers, thereby expanding the selection of polymer composite materials and manufacturing processes.

Considering the application of the carbonated polymer composite given the results found potential utility of the printed carbonated composite is as a personal, portable, and on-demand CO₂ phase transformation storage medium. The critical point to transform the gas into a supercritical fluid occurs at a minimum temperature and pressure of 30.98° C. and 72.79 atm (7.38 MPa), respectively.

Exemplary process parameters that may be used with this invention are summarized in Table 1 below. As previously noted, the parameters may be modified to accommodate the requirements of the gas used or the printer employed for 3D printing.

TABLE 1
Process parameters useful for creating carbonated polymer
according to the present invention.

| | Thickness | |
|---|---|---|
| Process | (μm) | UV Dose/Time |
| Carbonation duration | — | 0 to 45 sec |
| Printed base layer | 200 | 86 mJcm⁻² |
| Printed sub-layers | 50 | 3.8 mJcm⁻² |
| IPA Rinse | — | 2 min spray |
| Air dry and storage | — | 5 min + 24 hour dry dark |
| | | storage |

What is claimed is:

1. A carbonated polymer composite, comprising:
a. A photosensitive resin, wherein the photosensitive resin is one of a water-soluble polymer or a non-water-soluble polymer;
b. A gas carbonated into the photosensitive resin, wherein the gas has a gas molecule with molecular weight of 30 amu or greater and a density greater than 1.204 kg/m\hat{ }3,

2. A carbonated polymer composite according to claim 1, wherein the photosensitive resin is isomalt.

3. A carbonated polymer composite according to claim 1, wherein the photosensitive resin is acrylate with a UV photoinitiator.

4. A 3D printed polymer, comprising:
a. A 3D printed carbonated polymer composite, including
i. a photosensitive resin, wherein the photosensitive resin is one of a water-soluble polymer or a non-water-soluble polymer;
ii. a gas carbonated into the photosensitive resin, wherein the gas has a gas molecule with molecular weight of 30 amu or greater and a density greater than 1.204 kg/m\hat{ }3, wherein the 3D printed carbonated polymer composite is 3D printed using the digital light protection 3D printing technique.

5. A carbonated polymer composite according to claim 4, wherein the photosensitive resin is isomalt.

6. A carbonated polymer composite according to claim 4, wherein the photosensitive resin is acrylate with a UV photoinitiator.

7. A carbonated polymer composite, comprising:
a. A photosensitive resin, wherein the photosensitive resin is one of a water-soluble polymer or a non-water-soluble polymer;
b. A carbon dioxide gas carbonated into the photosensitive resin,

8. A carbonated polymer composite according to claim 7, wherein the photosensitive resin is isomalt.

9. A carbonated polymer composite according to claim 7, wherein the photosensitive resin is acrylate with a UV photoinitiator.
